(19) United States
(12) Patent Application Publication
(10) Pub. No.: US 2025/0347351 A1
(43) Pub. Date: Nov. 13, 2025

(54) Single-Piece Dynamic Seat

(71) Applicant: DeltaValve, LLC, Sandy, UT (US)

(72) Inventor: Filiberto R. Jimenez, Sandy, UT (US)

(21) Appl. No.: 18/661,221

(22) Filed: May 10, 2024

(51) Int. Cl. F16K 25/00; F16K 1/42

(52) U.S. Cl. CPC F16K 25/005; F16K 1/427

(57) ABSTRACT

A dynamic coking isolation valve seat machine manufactured from a single piece of metal and that includes a system of dynamic disc, such as a disc spring or Belleville washer that activate the seat.

### BACKGROUND

Petroleum refining operations in which crude oil is processed frequently produce residual oils that have very little value. The value of residual oils can be increased using a process known as delayed coking. Residual oils, when processed in a delayed coker, are heated in a furnace to a temperature sufficient to cause destructive distillation in which a substantial portion of the residual oil is converted, or “cracked” into usable hydrocarbon products and the remainder yields a residual petroleum by-product which is pumped into a large vessel known as a coke drum.

The production of coke is a batch process. Each delayed coker unit usually contains more than one coke drum. In delayed coking, the feed material is typical residuum from vacuum distillation towers and frequently includes other heavy oils. The feed is heated as it is sent to one of the coke drums. The feed arrives at a coke drum with a temperature ranging from 870 to 910 degrees Fahrenheit. Typical drum overhead pressure ranges from 15 to 35 PSIG. Coker feedstock is deposited as a hot liquid slurry in a coke drum. Under these conditions cracking proceeds and lighter fractions produced flow out of the top of the coke drum and are sent to a fractionation tower where they are separated into vaporous and liquid products. A solid residuum called coke is also produced and remains within the drum. When a coke drum is filled, residual oil from the furnace is diverted to another coke drum. When a coke drum is filled to the desired capacity, and after feedstock is diverted to another drum, steam is typically introduced into the drum to strip hydrocarbon vapors off of the solid material. The material as remaining is the coke drum cools and is quenched. Solid coke forms as the drum cools and must be removed from the drum so that the drum can be reused. While coke is being cooled in one drum and while the cooled solid coke is being extracted from that drum, a second drum is employed to receive the continuous production of coke feedstock as part of the delayed coker process. The use of multiple coke drums enables the refinery to operate the furnace and fractionating tower continuously. Drum switching frequently ranges from 10 to 24 hours.

In typical coking operations dramatic heat variances are experienced by elements in the coking operation. For example, a coke drum is filled with incoming by-product at about 900 degrees Fahrenheit and subsequently cooled after being quenched to nearly ambient temperatures. Not surprising, this repetitive thermal cycling may create or cause significant problems including stark heat distribution variance throughout various components of the valve system. The heated residual by-product utilized in coking operations comes into contact with not only the coke drum, but valve and seat components. This heating and subsequent cooling may result in expansion of various elements within a valve system. As previously mentioned, the delayed coking process typically comprises at least two vessels so that while one is being filled the other is being purged of material and prepared to receive another batch of by-product. Thus, during the off cycle, when a vessel is being purged of its contents, it will cool and return to a state of equilibrium. It is this cyclical pattern of dispensing hot residual by-product into a cooler coke drum and subsequently cooling the by-product that leads to thermal differential and stress within the coke drum, a valve, the valve parts and piping. It is the cyclical loading and unloading and stressing and destressing of a coke drum, valve or piping that is referred to as thermal cycling. Thermal cycling typically results in weakening or fatiguing of a coke drum, a valve and its parts which may lead to a reduction in the useful life of components. Uneven heat distributions or thermal variants existing between various components of the seat system can result in decreased longevity of the valve components and the valve body.

Also, because coke is formed using pressure, the deheading valve must form a seal to allow the pressure to build within the coke drum. This seal is generally formed using tight tolerances between the components of the deheading valve such as between the seats and the blind. These tight tolerances, however, increase the force required to slide the blind between the seats to open and close the valve. Also, due to this pressure, it is common to pressurize the internal compartments of the deheading valve such as by providing steam to the internal compartments. If a deheading valve does not provide a good seal, large amounts of steam will escape, which increases the total amount of steam required for production. In many cases, the cost of supplying steam to pressurize the valve can be significant. Accordingly, valves that prevent excessive steam leakage provide additional economy to the system.

In addition to decoking unheading applications, other petroleum refining applications can utilize similar valve technology. For example, isolation valves are commonly used to control the flow of hydrocarbon products. These applications comprise decoking valves, bypass valves, transfer line valves and other applications. These applications may also require steam pressure in the valve body to offset the line pressure and prevent flow of hydrocarbon products into the valve. These valves can also benefit from a superior seal to prevent steam losses and unnecessary valve maintenance.

Dynamic isolation valve seats manufactured by combining multiple products have disadvantages including the presence or formation of leak paths where a weld or a fit is not complete. In addition, sourcing parts for such an isolation valve seat is expensive and cumbersome. Furthermore, assembling an isolation vale seat is requires significant labor costs and expertise.

### BRIEF SUMMARY

A system of dynamic discs can be configured to create a dynamic coking isolation seat by virtue of having a combination of features in the system that in operation causes or cause the system to dynamically perform the actions. One or more dynamic discs can be configured to perform particular operations or actions by virtue of manufacturing that, when installed in a coking isolation valve apparatus, cause the apparatus to perform. One general aspect includes dynamic discs to live load the seat. The coking isolation valve seat also includes machining into a single annular piece the dynamic discs, a seat base structure, a first dynamic disc, a second dynamic disc, and a dynamic seat where the first dynamic disc is connected at a proximal edge to the base seat structure, the first and second dynamic discs are connected at a distal edge, and the second dynamic disc is connected to the dynamic seat at a proximal edge. Other embodiments of this aspect include corresponding apparatus, and structure, each configured to perform the actions of the methods.

One general aspect includes a coking isolation valve seat. The coking isolation valve seat also includes a single-piece annular seat may include a seat base structure, a first dynamic disc, and a second dynamic disc; a dynamic seat where the first dynamic disc is connected at a proximal edge to the base seat structure, the first and second dynamic discs are connected at a distal edge, and the second dynamic disc is connected to the dynamic seat at a proximal edge; and a liner engaged against the seat base structure and extending along a plane formed at the proximal annular wall Other embodiments of this aspect include corresponding systems and apparatus, each configured to perform the actions of the methods.

One general aspect includes a method of manufacturing an isolation valve from a single piece of metal. The method of manufacturing also includes manufacturing a single piece of metal into an annular ring; machining a seat base structure into a first end of the annular ring; machining a first dynamic disc into a portion of the annular ring adjacent the seat base structure; machining a dynamic seat into a second end of the annular ring; and machining a second dynamic disc into a portion of the annular ring between the first dynamic ring and the dynamic seat, where the seat base structure, the first dynamic disc, the second dynamic disc and the dynamic seat are formed in a single piece of metal. Other embodiments of this aspect include corresponding systems and apparatus each configured to perform the actions of the methods.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows a profile cut-away view of the coker isolation valve seat.

FIG. 2 shows a perspective cut-away view of the coker isolation valve seat.

FIG. 3 shows a perspective view of the coker isolation valve seat.

FIG. 4 shows a method of manufacturing a coker isolation valve seat.

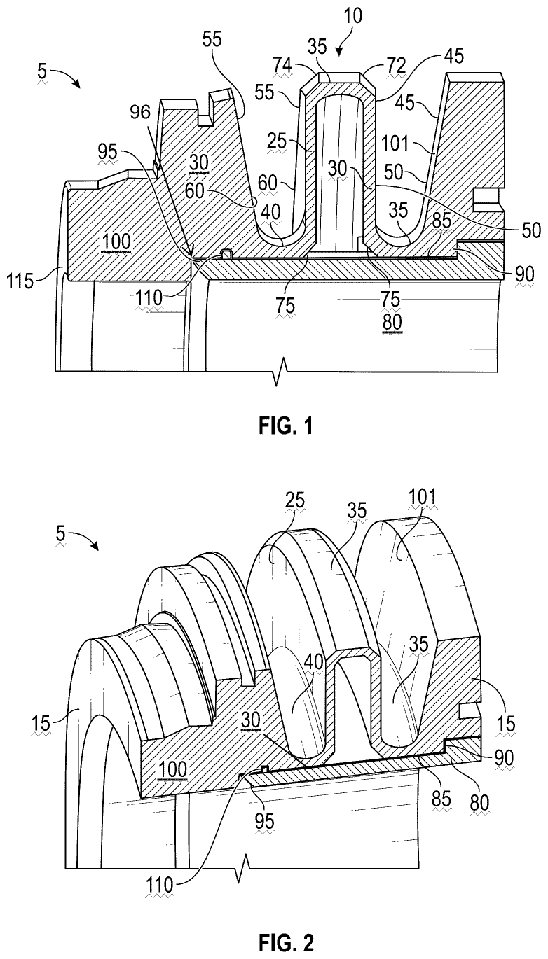

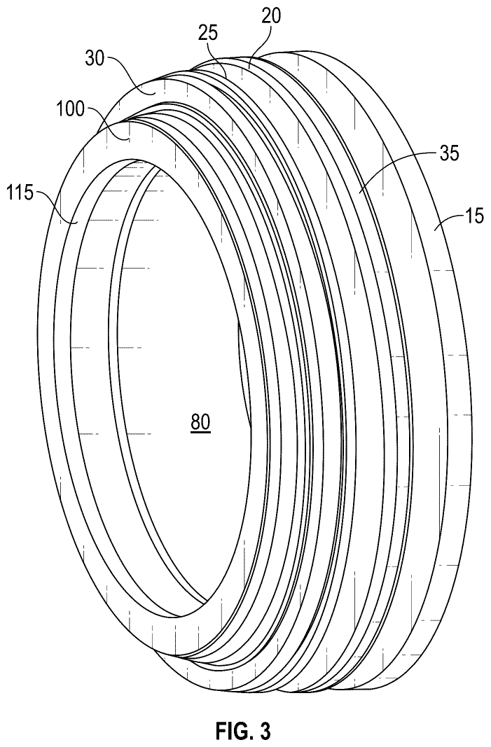

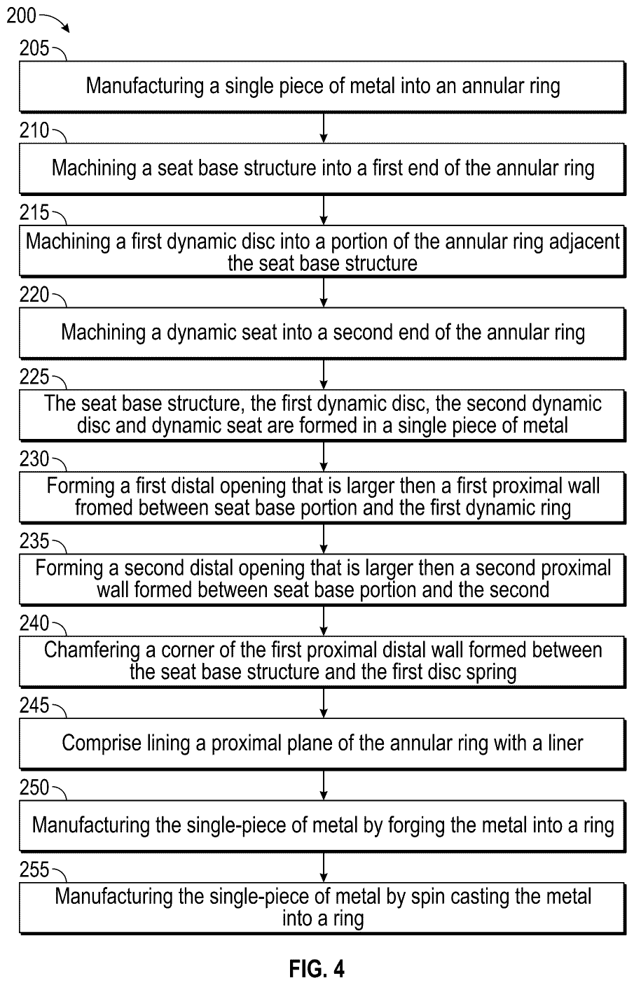

### DETAILED DESCRIPTION OF THE INVENTION

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations.

Some embodiments comprise a coking isolation valve seat 5. In some embodiments the coking isolation valve seat comprises a single-piece annular seat 10. The advantage of using a single-piece annular ring to make the isolation valve is the elimination of leak paths through the ring that can form between two pieces of metal that are welded or brazed together. In addition, using a single piece annular ring reduces or eliminates significant manufacturing costs associated with labor, materials sourcing and quality control associated with labor, materials and manufacturing.

In some embodiments the coking isolation valve seat further comprises a seat base structure 15. In some embodiments the seat base structure comprises a first end of the single-piece annular seat 10. In some embodiments the coking isolation valve seat further comprises a first dynamic disc 20. In some embodiments the coking isolation valve seat further comprises a second dynamic disc 25. In some embodiments the coking isolation valve seat further comprises a dynamic seat 30 wherein the first dynamic disc 20 is connected at a first proximal edge 30 to the seat base structure 15, the first 20 dynamic disc and second dynamic disc 25 are connected at a distal edge 35, and the second dynamic disc 25 is connected to the dynamic seat 30 at a second proximal edge 40.

In some embodiments of the coking isolation valve seat 5 comprise a lacuna formed on the distal plane of the annular ring. In some embodiments the lacuna comprises a distal space 45 between the distal edge of the seat base structure 15 and the distal edge of the first dynamic disc 20. In some embodiments the distal space 45 is greater than the proximal space 50 formed on the interior concave surface formed between the seat base structure 15 and the first dynamic disc 20.

In some embodiments of the coking isolation valve seat 5 comprise a lacuna formed between the second dynamic disc and the dynamic seat. In some embodiments the lacuna comprises the distal space 55 between the dynamic seat 30 and the second dynamic disc 25 is greater than the concave proximal space 60 between the dynamic seat 30 and the second dynamic disc 25. In some embodiments the distal portion 45, 55 of the lacuna is wider than the proximal concave portion 35, 40 of the lacuna to allow removal of chips during machining. In some embodiments the distal portion of the lacuna 45, 55 is wider than the proximal concave portion 35, 40 of the lacuna to shape the dynamic springs and change the spring constant. In some embodiments the wall of the adjoining structure ie. seat base structure 15 or dynamic seat 30 is angled, while the adjoining dynamic disc 20, 25 is orthogonal the primary axis of the coking isolation valve seat 5. In some embodiments the angle of the wall is selected to manipulate the spring constant of the dynamic disc. In some embodiments the slope of the angle is used to manipulate the spring constant of the dynamic disc. In some embodiments the placement of the change in angle is used to manipulate the spring constant of the dynamic disc. In some embodiments the angle change occurs on the proximal end of the dynamic disc. In some embodiments the angle change occurs on the distal end of the dynamic disc. In some embodiments the angle change occurs between the proximal end and the distal ends of the dynamic disc. In some embodiments of the coking isolation seat 5 the first dynamic disc 15 and the second dynamic disc 25 are substantially parallel. Some embodiments of the coking isolation seat 5 further comprise a seat base structure 15 interior wall 101 that is non-coplanar with the first dynamic disc 20. Similarly, in some embodiments of the coking isolation seat 5 other machined surfaces forming the lacuna walls are non-coplanar.

In some embodiments a plurality of dynamic discs may be machined into the coking isolation valve seat stacked to modify the spring constant or the amount of deflection. In some embodiments the dynamic discs are staked in the same direction to add the spring constant in parallel, creating a stiffer joint (with the same deflection). In some embodiments the dynamic discs are staked in an alternating direction, to reduce the spring constant and achieve greater deflection. In some embodiments the spring constant is further modified by including a positive pressure on lacuna 45, 55 to increase the force exerted on the seat. In some embodiments using a positive pressure in the lacuna unloads the pressure on the first dynamic disc and the second dynamic disc.

In some embodiments of the coking isolation valve 5 the first dynamic disc 20 and the second dynamic disc 25 are oriented in the same direction. In some embodiments of the coking isolation valve 5 the first dynamic disc 20 and the second dynamic disc 25 are oriented in alternating directions. In some embodiments the direction of the dynamic disc orientation is achieved by the placement of the conical extension at the proximal end of the disc, at the distal end of the disc, or between the proximal and distal ends of the dynamic disc.

In some embodiments of the coking isolation valve 5 the distal edge 35 between the first dynamic disc 20 and the second dynamic disk 25 further comprises chamfered corners 65. In some embodiments removing material at the corner removes stiffness in the dynamic seat. In some embodiments of the coking isolation valve 5 the proximal edge 35 between the first dynamic disc 20 and the seat base structure 15 further comprises a chamfered corner 70. In some embodiments of the coking isolation valve 5 the proximal edge 40 between the second dynamic disc 25 and the dynamic seat 30 further comprises a second chamfered corner 75. In some embodiments the corner between the first dynamic disc 20 and the distal edge 35 is chamfered 72. In some embodiments the corner 74 between the distal edge and the second dynamic disc 25 is chamfered. In some embodiments the chamfered corner disperses stress forces created in the extreme heat and pressure created during the valve's operation.

In some embodiments the coking isolation valve 5 further comprises a liner 80 engaged against the seat base structure 15 and extending along a plane formed at the interior annular wall 85. In some embodiments liner 80 is a sheath that abuts a portion the interior wall of the coking isolation valve 5. In some embodiments the liner prevents the cavity 110 formed between the first disc spring 20 and the second disc spring 25 from filling with process fluid. In some embodiments the liner 80 comprises a stop 90 configured to limit the distance over which the dynamic discs can travel. In some embodiments the liner protects the coking isolation valve 5 from yielding or damage which can result from over-compression of the valve. In some embodiments the of isolation valve of the liner comprises a knife-blade edge 95. In some embodiments the knife-blade edge is configured to engage against the dynamic seat 30. In some embodiments the knife-blade edge 95 is configured to cut through coke fines or process fluid which may accumulate on the interior wall 96 of the seat 30. In some embodiments the coking isolation seat 5 further comprises an extended seat 100 extending transversely axial from the seat 30. In some embodiments the seat plate 115 is hard chromed to resist heat and maintain more temperature uniformity through the coking isolation valve seat. In some embodiments the liner is configured to contact the packing 110 to isolate the cavity between the first dynamic disc and the second dynamic disc. In some embodiments the portion of the liner that abuts the packing comprises an increased thickness to prevent yielding during the 700 degree Celsius differential that can occur during the heat cycle.

Some embodiments of the coking isolation valve seat 5 comprise a single-piece annular seat 10 further comprising a seat base structure 15, a first dynamic disc 20, and a second dynamic disc 25. Some embodiments of the coking isolation valve seat 5 further comprise a dynamic seat 30. Some embodiments of the coking isolation valve seat 5 further comprise a first dynamic disc 20 connected at a first proximal edge 30 to the base seat structure 15. In some embodiments of the coking isolation valve seat 5 the first dynamic disc 20 and second dynamic disc 25 are connected at a distal edge 35, and the second dynamic disc 25 is connected to the dynamic seat 30 at a second proximal edge 40. In some embodiments a liner 80 is engaged against the seat base structure 15 and extending along a plane 85 formed at the proximal annular wall.

Some embodiments comprise a method of manufacturing a coking isolation valve seat 200 from a single piece of metal. Some embodiments comprise manufacturing a single piece of metal into an annular ring 205. Some embodiments comprise machining a seat base structure into a first end of the annular ring 210. Some embodiments comprise machining a first dynamic disc into a portion of the annular ring adjacent the seat base structure 215. Some embodiments comprise machining a dynamic seat into a second end of the annular ring 220. Some embodiments comprise machining a second dynamic disc into a portion of the annular ring between the first dynamic ring and the dynamic seat. Some embodiments comprise the seat base structure, the first dynamic disc, the second dynamic disc and the dynamic seat are formed in a single piece of metal 225.

Some embodiments comprise forming a first distal opening that is larger than a first proximal wall formed between seat base portion and the first dynamic ring 230. Some embodiments comprise forming a second distal opening that is larger than a second proximal wall formed between seat base portion and the second 235. Some embodiments comprise chamfering a corner of the first proximal distal wall formed between the seat base structure and the first disc spring 240. Some embodiments comprise lining a proximal plane of the annular ring with a liner 245. Some embodiments comprise manufacturing the single piece of metal by forging the metal into a ring 250. Some embodiments comprise manufacturing the single piece of metal by spin casting the metal into a ring 255.

In some embodiments the coking isolation valve seat may be used with delayed coking, ethylene service, mining industry, fluidized catalyst cracking unit, vacuum distillation unit, carbon black production, molecular sieve services. In some embodiments the seat is utilized in Coke Drum Unheading Top and Bottom Automated Valves where a feedline may operate at 500 C (940 F) Isolation. In some embodiments the delayed coking involves Overhead Vapor 24″ to 36″ Valves Coking Application. In some embodiments the coking isolation valve seat improves reliability where one valve can replace two Ball and Gate Valves. In some embodiments the coking isolation valve seat improves ethylene service including coking and fouling service. In some embodiments the coking isolation valve seat improves Mining Industry with its Highly abrasive service replace less reliable valves and improves cast operating/cycle times common in mining industry applications. In some embodiments the coking isolation valve seat improves Fluidized Catalyst Cracking Unit Bottom Slurry, Emergency Shut Down, and Fast Operating. In some embodiments the coking isolation valve seat improves vacuum distillation unit such as vacuum tower heater isolation valves. In some embodiments the coking isolation valve seat improves carbon black production to process vent gas. In some embodiments the coking isolation valve seat improves molecular sieve service with high temperature wet and dryer catalyst. In some embodiments the isolation valve seat may be purged with a liquid, steam or nitrogen. In some embodiments the isolation valve seat may be utilized for hydrocarbon liquid purge.

It is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. A coking isolation valve seat comprising:
a single-piece annular seat;
a seat base structure;
a first dynamic disc;
a second dynamic disc; and
a dynamic seat wherein the first dynamic disc is connected at a proximal edge to the seat base structure, the first and second dynamic discs are connected at a distal edge to the seat base structure, and the second dynamic disc is connected to the dynamic seat at a proximal edge.

2. The coking isolation valve seat of claim 1 wherein the single-piece annular seat is configured to no leak path through the single-piece annular seat.

3. The coking isolation valve seat of claim 1 wherein a distal space between the seat base structure and the first dynamic disc is greater than a proximal space between the seat base structure and the first dynamic disc.

4. The coking isolation valve seat of claim 1 wherein a distal space formed between the dynamic seat and the second dynamic disc is greater than a proximal space formed between the dynamic seat and the second dynamic disc.

5. The coking isolation valve of claim 1 wherein the dynamic discs are oriented in the same direction.

6. The coking isolation valve of claim 1 wherein distal edge between the first dynamic disc and the second dynamic disc further comprises chamfered corners.

7. The coking isolation valve of claim 1 wherein proximal edge between the first dynamic disc and the seat base structure further comprises a chamfered corner.

8. The coking isolation valve of claim 1 wherein proximal edge between the second dynamic disc and the dynamic seat further comprises a chamfered corner.

9. The coking isolation valve of claim 1 further comprising a liner engaged against the seat base structure and extending along a plane formed at a proximal annular wall.

10. The coking isolation valve of claim 9 wherein the liner comprises a stop configured to limit a distance over which the first dynamic disc and the second dynamic disc is configured to travel.

11. The isolation valve of claim 9 wherein liner comprises a knife-blade edge configured to engage against the dynamic seat.

12. The coking isolation seat of claim 1 further comprising a seat base structure interior wall that is non-coplanar with the proximal edge of the first dynamic disc.

13. A coking isolation valve seat comprising:
a single-piece annular seat further comprising a seat base structure, a first dynamic disc, and a second dynamic disc;
a dynamic seat wherein the first dynamic disc is connected at a proximal edge to the base seat structure, the first and second dynamic discs are connected at a distal edge, and the second dynamic disc is connected to the dynamic seat at a proximal edge; and
a liner engaged against the seat base structure and extending along a plane formed at a proximal annular wall.

14. A method of manufacturing an isolation valve from a single piece of metal comprising:
manufacturing a single piece of metal into an annular ring;
machining a seat base structure into a first end of the annular ring;
machining a first dynamic disc into a portion of the annular ring adjacent the seat base structure;
machining a dynamic seat into a second end of the annular ring; and
machining a second dynamic disc into a portion of the annular ring between the first dynamic ring and the dynamic seat, wherein the seat base structure, the first dynamic disc, the second dynamic disc and the dynamic seat are formed in a single piece of metal.

15. The method of claim 14 further comprising forming a first distal opening that is larger than a first proximal wall formed between seat base portion and the first dynamic ring.

16. The method of claim 14 further comprising forming a second distal opening that is larger than a second proximal wall formed between seat base portion and the second.

17. The method of claim 14 further comprising chamfering a first proximal distal wall formed between the seat base structure and the first disc spring.

18. The method of claim 14 further comprising lining a proximal plane of the annular ring with a liner.

19. The method of claim 14 wherein the manufacturing the single piece of metal further comprises forging the metal into a ring.

20. The method of claim 14 wherein the manufacturing the single piece of metal further comprises spin casting the metal into a ring.
